(19) United States
(12) Patent Application Publication
(10) Pub. No.: US 2015/0375139 A1
(43) Pub. Date: Dec. 31, 2015

(54) An Extraction Column and Process for Use Thereof

(71) Applicant: SULZER CHEMTECH AG, Winterhur (CH)

(72) Inventors: Fredy Wieland, Hegenheim (FR); Jörg Koch, Kandern (DE); Juan Ramon Herguijuela, Auggen (DE)

(21) Appl. No.: 14/378,598

(22) PCT Filed: Nov. 13, 2012
(86) PCT No.: PCT/EP2012/072480

§ 371 Date: Aug. 13, 2014

(30) Foreign Application Priority Data
Feb. 14, 2012 (EP) 12155285.5

(51) Int. Cl. B01D 11/04; C10G 21/20

(52) U.S. Cl. CPC B01D 11/0434; B01D 11/043; C10G 21/20; B01D 2011/002

(57) ABSTRACT

A counter-current liquid-liquid extraction column (1) adapted for the flow of two or more liquids (2) therein is disclosed. The column comprises within one common vessel (3): a first inlet (41) for a first liquid feed stream (51), a second inlet (42) for a second liquid feed stream (52), a first outlet (61) for a product stream (71), a second outlet (62) for a byproduct stream (72), a mixing section (8) comprising an agitation means (9), a static section (10) comprising a packing (11), optionally a collector (12) and/or distributor (13), characterized in that within the common vessel (3) are only one mixing section (8) and only either one or two static sections (10). The invention further relates to a process for using said column. The present invention further relates also to the use of the column or process in removing aromatic compounds from organic streams, in treating an oil stream of a refinery, or in a liquid-liquid extraction process.

### BACKGROUND OF THE INVENTION

The present invention relates to a counter-current liquid-liquid extraction column. The present invention also relates to a process for using said column and the use of said column or process in removing aromatic compounds from organic streams, in treating an oil stream of a refinery, or in a liquid-liquid extraction process having at least two feed streams of different density, interfacial tension or viscosity.

Liquid-liquid extraction, which is also known as solvent extraction and partitioning, is a method to separate compounds based on their relative solubilities in two different immiscible liquids, often water and an organic solvent. It is an extraction of a substance from one liquid phase into another liquid phase and is of utility, for example, in the work-up after a chemical reaction to isolate and purify the product(s) or in removing valuable or hazardous components from waste or byproduct streams in a variety or industrial processes. The extracted substances may be inorganic in nature such as metals or organic such as fine chemicals. Therefore liquid-liquid extraction finds wide applications including the production of fine organic compounds, the processing of perfumes, nuclear reprocessing, ore processing, the production of petrochemicals, and the production of vegetable oils and biodiesel, among many other industries. Certain specific applications include the recovery of aromatics, decaffeination of coffee, recovery of homogeneous catalysts, manufacture of penicillin, recovery of uranium and plutonium, lubricating oil extraction, phenol removal from aqueous wastewater, and the extraction of acids from aqueous streams.

In a typical industrial application, a process will use an extraction step in which solutes are transferred from an aqueous phase to an organic phase. Typically a subsequent scrubbing stage is used in which undesired solutes are removed from the organic phase, and then the desired solutes are removed from the organic phase in a stripping stage. The organic phase may then be treated to make it ready for use again, for example, by washing it to remove any degradation products or other undesirable contaminants.

Counter-current liquid-liquid extraction processes are particularly useful in obtaining high levels of mass transfer due to the maintenance of a slowly declining differential over the path of the counter-current flow. For example, industrial process towers generally make use of counter-current liquid extraction systems in which liquids flow continuously and counter-currently through one or more chambers or columns. The chambers or columns may have specially designed apparatuses mounted within them such as agitators for affecting the physical properties (e.g., droplet size) of the liquid and tower packing which serves to obstruct the direct flow of the liquids. Packing also provides for increased contact between lighter rising liquids and heavier settling liquids, and better contact means higher efficiency of the mass transfer process.

Liquid-liquid process towers and their columns are typically constructed to provide descending flow of a heavier liquid from an upper portion of the tower and ascending liquid flow of a lighter liquid from a lower portion of the tower. It is generally desirable to provide apparatuses and methods affording efficient mass transfer, or liquid-liquid contact, such that contact of the fluids can be accomplished with a minimum pressure drop through a given zone of minimum dimensions. Therefore high efficiency and low pressure drop are important design criteria in liquid-liquid extraction operations. Sufficient surface area for liquid-liquid contact is necessary for the reduction or elimination of heavy liquid entrainment present in the ascending lighter liquid. Most often, it is necessary for the structured packing array in the column to have sufficient surface area in both its horizontal and vertical plane so that fractions of the heavy constituents are conducted downwardly, and the lighter liquid is permitted to rise upwardly through the packing with minimum resistance. With such apparatuses, the heavy and light constituents of the feed are recovered at the bottom and top of the tower, respectively.

Counter-current liquid-liquid extraction columns may be passive or static packed columns. Static extraction columns typically rely completely on the packing/internals and fluid flow velocities past the internals to create turbulence and droplets. They offer the advantages of (1) availability in large diameters for very high production rates, (2) simple operation with no moving parts and associated seals, (3) requirement for control of only one operating interface, and (4) relatively small required footprint compared to mixer-settler equipment. High flows are typically required for obtaining adequate mass transfer though. Such passive columns suffer from limitations in that channeling may occur in which very little contact occurs between the liquids. Another problem is that generally only relatively few and large droplets of the first liquid phase are dispersed for relatively short periods of time in the second continuous liquid phase in passive columns. Thus relatively low degrees of mixing and thus reduced mass transfer and stage efficiency are associated with passive or static columns. As a result applications of static extraction columns are typically limited to those involving low viscosities (less than about 5 cP), low to moderate interfacial tensions (typically 3 to 20 dyn/cm equal to 0.003 to 0.02 N/m), low to moderate density differences between the phases, and no more than three to five equilibrium stages.

The low mass-transfer efficiency of a static extraction column, especially for systems with moderate to high interfacial tension or density differences, may be improved upon by mechanically agitating or pulsating the liquid-liquid dispersion within the column to better control drop size and population density (dispersed-phase holdup). Many different types of mechanically agitated extraction columns have been proposed. The more common types include various rotary-impeller columns, and the rotating-disk contactor or pulsed columns such as the reciprocating-plate column. In contrast to static extraction columns, agitated extraction columns are well-suited to systems with moderate to high interfacial tension and can handle moderate production rates.

Nonetheless it is important to provide just the right amount of mixing in agitated extraction columns. Higher agitation (more mixing) minimizes mass transfer resistance during extraction but contributes to the formation of small and difficult-to-settle droplets or emulsions and thus entrainment or “flooding” in the process. In designing a liquid-liquid extraction process, normally the goal is to generate an unstable dispersion that provides reasonably high interfacial area for good mass transfer during extraction and yet is easily broken to allow rapid liquid-liquid phase separation after extraction. Therefore over agitation may unfortunately require very long subsequent settling times in order to separate the phases.

The incorporation of agitator systems into passive static extraction columns in order to allow for the input of energy for increasing mixing is known from U.S. Pat. No. 2,493,265; U.S. Pat. No. 2,850,362; and WO 97/10886. Such agitated packed columns are characterized by a series of several alternating mixing and calming sections. The mixing sections have an agitator to promote intimate equilibrium contact between the liquids. The calming sections contain packing to stop the circular motion of the liquids and to facilitate their separation. Nonetheless such agitated packed columns according to the prior art are not well suited for systems that tend to emulsify easily owing to the high shear rate generated by a rotating impeller. In particular, the use of alternating mixing and calming sections means that any emulsions that are separated by a calming section will simply be regenerated by the subsequent mixing section in the series. Therefore the emulsions will be progressively built up by the high shear rates in each mixing section over the path of the column.

An additional problem is that many physical properties may change significantly with changes in chemical concentration during extraction. These properties may include interfacial tension, viscosities, and densities, and they strongly affect the mass transfer and thus extraction performance. In particular, changes in these properties promote problems with emulsion formation for a particular set of column conditions. Extraction processes involving high degrees of mass transfer are particularly susceptible to such changes in physical properties over the column length. One type of extraction column—static (passive) or agitated (active)—will not be able to deal well such systems and their property changes.

In such cases of changing physical properties, apparatuses may be used based on a combination of two or more different individual columns. Each column may have a different design and type of internals for optimum use with the specific physical properties at that particular stage of the extraction. Such apparatuses however require two individual column shells, two sets of feed pumps and two sets of process controllers. The process streams are processed by passing sequentially through these at least two columns. Such apparatuses based on a combination of individual columns have several disadvantages such as requiring a large number of auxiliaries such as pumps and piping, and elaborate process control means. Furthermore internals like distributors and/or collectors and phase separation will be necessary between each of the various columns of the apparatus.

The earlier discussed agitated packed columns of U.S. Pat. No. 2,493,265; U.S. Pat. No. 2,850,362; and WO 97/10886 are also not suited to extraction of systems involving significant changes in physical properties due to changes in concentrations over the course of the extraction process and column. The disclosed columns are based on a substantially symmetrical arrangement of alternating mixing and calming sections over the column length, whereas the chemical concentration of the specie and physical property are asymmetrical over the extraction and will either increase or decrease along the column axis. Therefore the disclosed columns cannot take advantage of the particular suitability of a mixing versus a static section for a particular concentration and set of physical properties at the start versus the end of the extraction process (e.g. at the bottom versus the top or vice versa in the case of a substantially vertical column).

In conclusion, it would be desirable to have an extraction column that would be better suited for extraction of systems involving significant changes in physical properties than those of the prior art, and while still offering adequate mass transfer efficiency and without a tendency to form emulsions or entrainment.

### SUMMARY OF THE INVENTION

Starting from this state of the art, it is an object of the invention to provide a simplified counter-current liquid-liquid extraction column that does not suffer from the previous mentioned deficiencies, particularly a lack of adequate mass transfer efficiency and/or tendency to form emulsions, especially when working with systems involving significant changes in physical properties during the extraction process. Further objects of the invention include providing a process for using said column and a use of said column or process in removing aromatic compounds from organic streams, in treating an oil stream of a refinery, or in a liquid-liquid extraction process having at least two feed streams of different density, interfacial tension or viscosity.

According to the invention, these objects are achieved by a counter-current liquid-liquid extraction column adapted for the flow of two or more liquids therein and comprising within one common vessel: a first inlet for a first liquid feed stream, a second inlet for a second liquid feed stream, a first outlet for a product stream, a second outlet for a byproduct stream, a mixing section comprising an agitation means, a static section comprising a packing, optionally a collector and/or distributor, wherein within the common vessel are only one mixing section and only either one or two static sections.

According to the invention, these further objects are achieved firstly by a counter-current liquid-liquid extraction process, wherein to the said column a first liquid feed stream is fed by means of the first inlet and a second liquid feed stream is fed by means of the second inlet, liquid-liquid contact occurs between the first stream and the second stream to form a product stream and a byproduct stream, and the formed product stream is removed by means of the first outlet, and the formed byproduct stream is removed by means of the second outlet.

Said column and said process is used in accordance with the invention in removing aromatic compounds from organic streams, in treating an oil stream of a refinery, or in a liquid-liquid extraction process having at least two feed streams of different density, interfacial tension or viscosity.

The present invention achieves these objects and provides a solution to this problem by means of a common vessel within which are only one mixing section and only either one or two static sections. As a result, the single mixing section provides the necessary mass transfer efficiency, whereas the one or two static sections may be arranged within the column to provide the required calming sections to allow for the separation of any emulsions formed in the case of systems having a tendency to form emulsions. Furthermore the addition of one or two static sections allows the energy input from the mixing section to be reduced while still providing adequate mass transfer. This beneficial reduction in energy input then also contributes to a reduction in emulsion formation.

In the case of systems involving significant changes in physical properties during the extraction process, the one mixing section and one or two static sections may be arranged within the column to provide the optimum extraction column conditions for the particular changing set of properties of the system to be extracted. For example, if the interfacial tension changes from a lower value to a higher value as a result of the mass transfer during the extraction, then the column may start with a static section at the beginning of the process (i.e. towards the bottom of a substantially vertical column) and finish with the mixing section at the end of the process (i.e. towards the top of a substantially vertical column). If the system would have a tendency to form emulsions, the mixing section could be followed by a static section to provide calming for facilitating separation. Likewise if the interfacial tension changes from a higher value to a lower value as a result of the mass transfer during the extraction, then the column may start with a mixing section and finish with a single static section.

These results are then surprisingly achieved without the need for any special elaborate apparatuses involving the combination of multiple columns, each with their own individual column shells, sets of internals, sets of feed pumps and sets of process and level controllers.

In a preferred embodiment, the column is substantially vertical, wherein within the common vessel is only one static section, and wherein the mixing section is preferably located substantially above the static section. This asymmetrical arrangement of column internals is particularly well-suited for dealing with systems in which the interfacial tension changes during the extraction as a result of the mass transfer. Locating the mixing section substantially above the static section is particularly beneficial for systems changing from a lower value to a higher value of interfacial tension as it passes from the lower section to the upper section of the column. Furthermore this system has a reduced tendency to form emulsions in that adding a static section to the mixing section in the column allows the energy introduced by the mixing section to be reduced while still providing adequate mass transfer efficiency.

Likewise, in a preferred embodiment of the process, the column is substantially vertical, preferably wherein within the common vessel of the column is only one static section, and wherein the mixing section is preferably located substantially above the static section, and wherein the density of the stream added by means of an inlet located within a bottom portion of the column is less than the density of the stream added by means of an inlet located within a top portion of the column. This process then has the same advantages of the previously mentioned column.

According to another preferred embodiment, the column additionally comprises a collector and/or distributor. A collector may be beneficially used to intercept liquid blowing down the column, for example, to use in feeding to a redistributor when the diameter of the column significantly changes, to aid in removal of liquid from the column, to remove liquid for recirculation in a “pump-around” loop, or to improve the mixing of a feed stream with a downward flowing liquid. For example, the static section(s) of the column will often have a smaller diameter than the mixing section. The even distribution of liquid and flow rates over the column cross-section by means of a distributor, especially in the case of a static section having packing, will strongly contribute to efficiency of the column and its internals. Therefore the use of a liquid distributor at all locations on the column at which a liquid feed stream is introduced will be beneficial.

According to another preferred embodiment, the column has no collector or distributor located between the mixing section and the one or two static sections. The combination of the mixing and static sections in one common vessel eliminates the need for these internals between the mixing and static sections. This unexpected and beneficial simplification is then in contrast to extraction apparatuses based on a combination of two or more columns.

According to another preferred embodiment of the column, the agitation means comprises either a magnetic drive unit or a motor, wherein the motor is located substantially above or substantially to the side of the mixing section. Magnetic drive units are beneficial in that they do not require holes and thus seals in the wall of the common vessel of the column for their operation. Therefore they will have lesser problems with potential leakage. Locating the motor to the side of the mixing section will eliminate the need for making a hole through a static section for the motor shaft. Similarly for preferred embodiments of the column having only one static section and wherein the mixing section is located substantially above the static section, locating the motor substantially above the mixing section eliminates the need for any holes or seals for shafts through the static section. Passing shafts through static sections would typically require the use of less common “doughnut” shaped packings.

In yet another preferred embodiment of the column, the packing comprises trays, a random packing, a structured packing, or combinations thereof. In the column, one of the liquids tend to wet the surface of the packing better and the other liquid passes across this wetted surface, where mass transfer takes place. Therefore packing will improve the intimate contact between the phases. Trays, random packing, and structured packing are particularly efficient in effecting this transfer. In particular, random and structured packings offer the advantage of a lower pressure drop across the column compared to plates or trays. Combinations of trays and structured packings make possible a combination of each of their respective favourable properties.

In still yet another preferred embodiment of the column, the column additionally comprises a third inlet located between the first inlet and the second inlet for the addition of a third liquid feed stream. A third liquid feed may comprise one or more extractants to beneficially increase the capacity of a solvent for the component to be extracted. Alternatively the third liquid may be a second solvent having specific selectivity for dissolving another component of the feed stream to be extracted. The use of additional solvents thus beneficially allows the selective extraction of additional components or the extraction process to be combined with a stripping, scrubbing or washing step within the same column.

Likewise in a preferred embodiment of the process having a substantially vertical column, a third liquid feed stream having a density greater then the density of the second stream added within a bottom portion of the column but less than the density of the first stream added within a top portion of the column is also added to the column. The third liquid feed is added by means of a third inlet located between the inlet in the bottom portion and the inlet in the top portion. The use of the third liquid feed stream makes possible then the same benefits of the previously mentioned preferred column embodiment.

In yet a further preferred embodiment of the column, the column additionally comprises a pulsing means in fluid connection with the column for increasing shear stress and dispersion within the column. Likewise in a further preferred embodiment of the process, a liquid within the column is pulsed by a pulsing means in order to increase the shear stress on and the dispersion of the liquid.

In still yet another preferred embodiment of the process, one of the streams comprises two or more organic compounds and the other stream comprises water, preferably wherein the first stream consists essentially of organic compounds and the other stream consists essentially of water. Such streams typically have quite different densities and often their physical properties change due to the mass transfer over the column. Therefore these streams benefit greatly from the process of the invention. In still further preferred embodiments in which the column is substantially vertical, the stream rich in organic compounds is added by means of an inlet located within a bottom portion of the column, and the other stream rich in water is added by means of an inlet located within a top portion of the column.

In another preferred embodiment of the process, the first liquid feed stream comprises a solvent and the second liquid feed stream comprises an oil and an aromatic compound, wherein the aromatic compound is extracted from the second stream by counter-current contact with the first stream within the column to yield a purified oil, wherein the extracted aromatic compound is removed with the solvent as part of a byproduct stream by means of a second outlet located within the bottom portion of the column, and wherein the purified oil is removed as part of a product stream by means of a first outlet located within the top portion of the column. Liquid-liquid extraction of aromatic compounds from oils typically involves substantial changes in physical properties during the course of the extraction, and thus such extractions benefit especially from the column and process of the invention.

Further aspects of the present invention include the use of the column or the process of the invention in removing aromatic compounds from organic streams, in treating an oil stream of a refinery, or in a liquid-liquid extraction process having at least two feed streams of different density, interfacial tension or viscosity. Such use benefits then from the previously discussed advantages of the column and the process of the invention.

One skilled in the art will understand that the combination of the subject matters of the various claims and embodiments of the invention is possible without limitation in the invention to the extent that such combinations are technically feasible. In this combination, the subject matter of any one claim may be combined with the subject matter of one or more of the other claims. In this combination of subject matters, the subject matter of any one process claim may be combined with the subject matter of one or more other process claims or the subject matter of one or more column claims or the subject matter of a mixture of one or more process claims and column claims. By analogy, the subject matter of any one column claim may be combined with the subject matter of one or more other column claims or the subject matter of one or more process claims or the subject matter of a mixture of one or more process claims and column claims. By way of example, the subject matter of claim 1 may be combined with the subject matter of any one of claims 9 to 15. In one embodiment, the subject matter of claim 9 is combined with the subject matter of any one of claims 1 to 8. In one specific embodiment, the subject matter of claim 10 is combined with the subject matter of claim 2. In another specific embodiment, the subject matter of claim 4 is combined with the subject matter of claim 11. By way of another example, the subject matter of claim 1 may also be combined with the subject matter of any two of claims 2 to 15. In one specific embodiment, the subject matter of claim 1 is combined with the subject matter of claims 2 and 9. In another specific embodiment, the subject matter of claim 11 is combined with the subject matters of claims 1 and 2. By way of example, the subject matter of claim 1 may be combined with the subject matter of any three of claims 2 to 15. In one specific embodiment, the subject matter of claim 1 is combined with the subject matters of claims 2, 9 and 11. In another specific embodiment, the subject matter of claim 10 is combined with the subject matters of claims 1, 7, and 13.

In yet another specific embodiment, the subject matter of claim 1 is combined with the subject matters of claims 2 to 9 and 11. In yet another specific embodiment, the subject matter of claim 9 is combined with the subject matters of claims 10 and 12 to 13. By way of example, the subject matter of any one claim may be combined with the subject matters of any number of the other claims without limitation to the extent that such combinations are technically feasible.

One skilled in the art will understand that the combination of the subject matters of the various embodiments of the invention is possible without limitation in the invention. For example, the subject matter of one of the above-mentioned preferred embodiments may be combined with the subject matter of one or more of the other above-mentioned preferred embodiments without limitation. By way of example, according to a particularly preferred embodiment of the process, the column is substantially vertical and within the common vessel of the column is only one static section, and the mixing section is preferably located substantially above the static section. By way of another example, according to another particularly preferred embodiment of the process, within the common vessel of the column no collector or distributor is located between the mixing section and the one or two static sections. By way of yet another example, according to another particularly preferred embodiment of the process, the column is substantially vertical, within the common vessel of the column is only one static section and the mixing section is preferably located substantially above the static section, and wherein the density of the stream added by means of the inlet located within a bottom portion of the column is less than the density of the stream added by means of the inlet located within a top portion of the column and the stream of lower density comprises two or more organic compounds and the stream of higher density comprises water.

### BRIEF DESCRIPTION OF THE DRAWINGS

The invention will be explained in more detail hereinafter with reference to various embodiments of the invention as well as to the drawings. The schematic drawings show:

FIG. 1 shows a schematic view of an embodiment of a counter-current liquid-liquid extraction column according to the invention.

FIG. 2 shows a schematic view of a preferred embodiment of a counter-current liquid-liquid extraction column according to the invention, in which the column is substantially vertical and within the common vessel of the column is only one static section and the mixing section is located substantially below the static section.

FIG. 3 shows a schematic view of a preferred embodiment of a counter-current liquid-liquid extraction column according to the invention, in which the column is substantially vertical and within the common vessel of the column is only one static section and the mixing section is located substantially above the static section.

FIG. 4 shows a schematic view of another preferred embodiment of a counter-current liquid-liquid extraction column according to the invention, in which the column is substantially vertical and within the common vessel of the column is only one static section and the mixing section is located substantially above the static section.

### DETAILED DESCRIPTION OF THE INVENTION

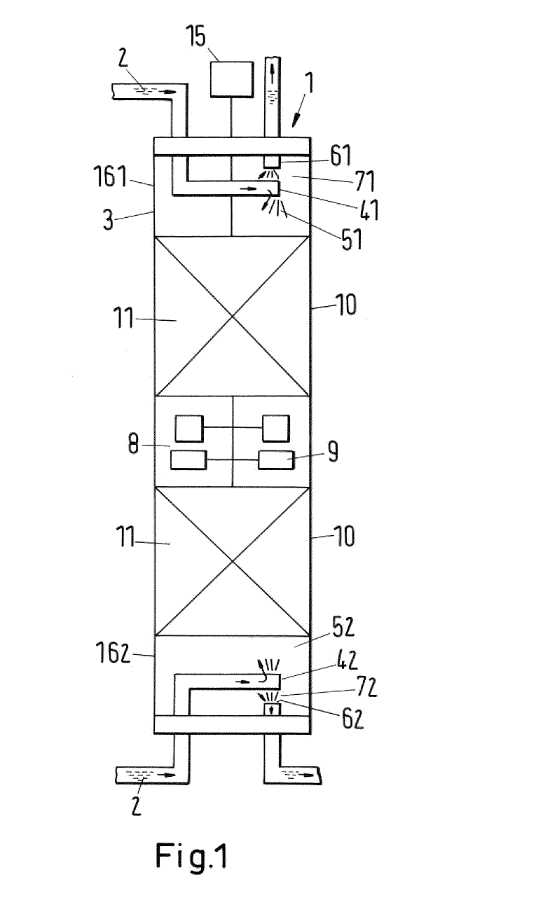

FIG. 1 shows a schematic view of an embodiment of a counter-current liquid-liquid extraction column according to the invention, which as a whole is labeled with reference number 1. The extraction column 1 is not specifically limited as to form, shape, construction or composition unless specifically indicated otherwise. Any material that can be fabricated can be made into a column 1. For reasons of economy, column shells are often made from FRP fiberglass reinforced plastic, stainless steel, Alloy 20, or any other material indicated for the specific application. Column internal components can be made from polypropylene or other plastics for low initial cost, or any other materials including metals depending upon the process requirements. In one embodiment the column 1 and its components are constructed of metals, plastics, glass or mixtures thereof. Suitable metals include carbon steel, stainless steel, nickel alloys, copper alloys, titanium and zirconium. Suitable engineering plastics include fluoropolymers such as PTFE, PVDF, or ETFE; PVC; and polypropylenes.

The embodiment in FIG. 1 shows a substantially vertical column 1, but it will be understood by one skilled in the art that other orientations of the column 1 are possible so long as technically feasible.

Extraction columns and their construction and operation are well known in the art, for example, as disclosed in Chemical Engineering Design, Vol. 6, Coulson & Richardson's Chemical Engineering Series, by R. K. Sinnott, John Metcalfe Coulson, and John Francis Richardson, 4th Ed. Published in 2005 by Elsevier (ISBN 0 7506 6538 6) or Handbook of Solvent Extraction by T. C. Lo and M. H. I. Baird, edited by C. Hanson, published in 1991 by Krieger Pub. Co. (ISBN-13: 978-0894645464). Unless indicated otherwise, conventional construction materials and means, as well as components and auxiliaries, may be used for the column 1, and the column 1 may be operated in an extraction process in a conventional manner as known in the art.

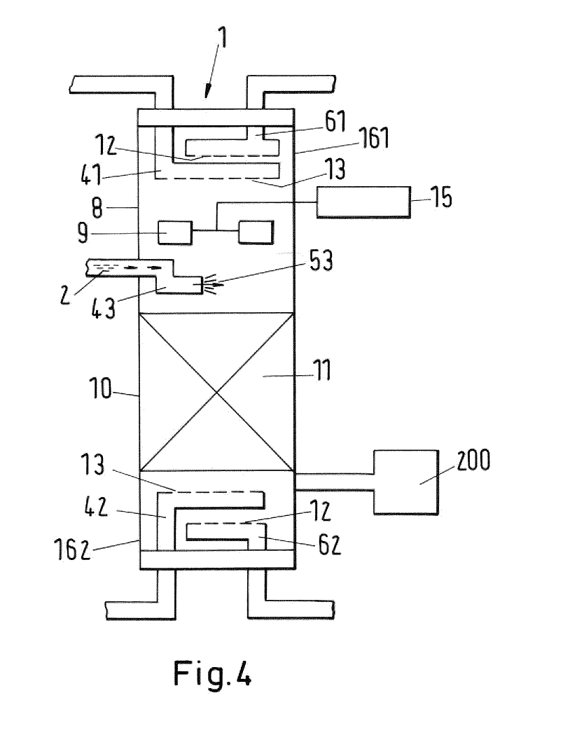

The column 1 is adapted for the flow of two or more liquids 2 therein and comprises within one common vessel 3: a first inlet 41 for a first liquid feed stream 51, a second inlet 42 for a second liquid feed stream 52, a first outlet 61 for a product stream 71, a second outlet 62 for a byproduct stream 72, a mixing section 8 comprising an agitation means 9, a static section 10 comprising a packing 11, optionally a collector 12 and/or distributor 13, wherein within the common vessel 3 are only one mixing section 8 and only either one or two static sections 10. Note: the optional collector 12 and/or distributor 13 are not shown in the embodiment of FIG. 1 for clarity, but they are shown in the embodiment in FIG. 4.

The liquids 2 are not specifically limited and each liquid 2, each liquid feed stream, 51 to 53, the byproduct stream 72, and the product stream 71 may comprise one or more organic compounds, solvents, water or mixtures thereof. The product stream 71 and the byproduct stream 72 are not specifically limited, and for clarity purposes the product stream 71 will be used here to refer to the less dense stream and the byproduct stream will be used to refer to the denser stream in the drawings unless specifically indicated otherwise.

The common vessel 3 is not specifically limited as to form, shape or composition. In the embodiment shown in FIG. 1 it is cylindrical in shape. The first inlet 41, second inlet 42, first outlet 61, and second outlet 62 are all conventional, as known in the art. The locations of the inlets 41 and 42 and outlets 61 and 62 within the column 1 are not specifically limited. In the embodiment shown in FIG. 1 the inlet 41 and outlet 61 are located within a top portion 161 of the column, and the inlet 42 and outlet 62 are located within a bottom portion 162 of the column. One skilled in the art will understand that the reverse geometry or a mixture thereof is within the scope of the invention.

In the embodiment shown in FIG. 1, the mixing section 8 is located within the common vessel 3 and in between two static sections 10, which are also located within the common vessel 3. On skilled in the art will understand that other arrangements of the mixing section 8 and the two static sections 10 are possible. For example, in one embodiment the mixing section 8 is below both static sections 10, and in another embodiment it is above them both. In some embodiments, it will be preferred to have the static sections 10 located within portions of the column 1 in which there is only a small difference in the densities of the liquids 2, and to have the mixing section 8 located within a portion of the column in which there is a large difference in the densities of the liquids 2.

The mixing section 8 comprises an agitation means 9, which is conventional as known in the art and not specifically limited. The agitation means 9 generates the agitation of the liquids 2 within the mixing section 8 as the liquids 2 pass in countercurrent flow through this section 8. The agitation imparted thereto is designed to reduce the size of liquid phase droplets dispersed into another continuous phase liquid.

In certain embodiments the agitation means 9 comprises one or more paddle agitators, discs, turbines, or their combinations. In the specific embodiment shown in FIG. 1, the agitation means 9 comprises two paddle agitators. Rotation of the vertical shaft of the agitation means 9 creates agitation with a non-vertical thrust. Agitation from such paddle agitators and the like has been shown to produce an extremely fine dispersed droplet configuration in such assemblies. In one embodiment, the blades are pitchless, being vertically mounted to produce intimate mixing without imparting either an upward or downward thrust on the liquid mixture, thereby permitting the liquids to separate by gravity due to their different densities.

In the embodiment shown in FIG. 1, the two paddle agitators are rotated by means of a vertical shaft connected to a motor 15. The motor 15 is conventional, and in one embodiment it is a variable speed drive electric motor. In general, electrically powered agitators will be preferred. In many embodiments, it will be preferred to have the motor 15 located substantially above the column so that the liquid phases are not in contact with the motor shaft seals. Such embodiments are easier to maintain, more durable, and safer due to a lesser likelihood of leakage. In less preferred embodiments in which a motor 15 is connected to the agitators by means of a shaft passing through a static section 10, it will be preferred to use doughnut shaped packing 11 to facilitate passage of the shaft.

The size of the agitation means 9 is not specifically limited, but one skilled in the art will understand that its size and construction will be such that it does not block in any substantial way the counter-current liquid flow of the liquids in the column and during agitation.

Each static section 10 comprises a packing 11. The packing 11 is conventional and well known in the art, such as trays, random packing, structured packing, or their combinations. In one preferred embodiment structured packing is used due to its superior performance. In certain embodiments the packing 11 comprises mass transfer elements known in the art as random packings, such as Raschig and/or Pall rings, saddles, such as e.g. Berl saddles, spheres, hooks, or by the tradenames NOR-PAC™, BIO-NET™, or Hel-X™. In certain other embodiments, the packing comprises structured packings such as those known by the trademarks Mellapak™ Montz-Pak™, Ralu-Pak™, SMV™, or Raschig Super-Pak™. In certain other specific embodiments the packings are made of fabric. In certain preferred embodiments, packings will be used which have smooth (non-grooved) surfaces. In a specific embodiment, the surface of the mass transfer element used is between 20 m²/m³ and 500 m²/m³. In another preferred embodiment, a combination of trays and structured packing is made, preferably one in which a dual flow tray is located in between each packing element.

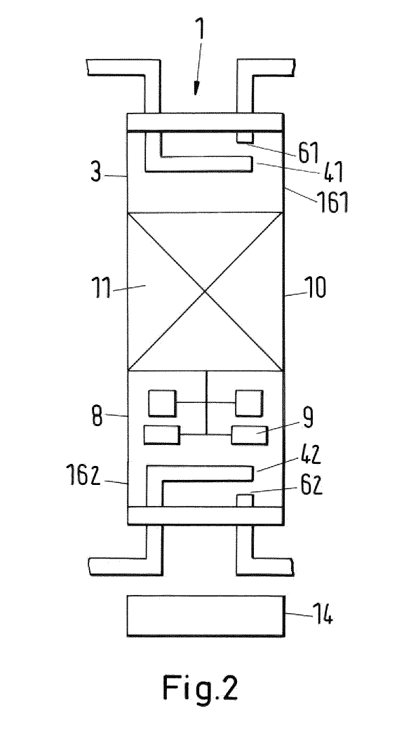

FIG. 2 shows a preferred embodiment of a counter-current liquid-liquid extraction column 1 according to the invention, in which the column 1 is substantially vertical and within the common vessel 3 of the column 1 is only one static section 11 and the mixing section 8 is located substantially below the static section 11. Shown in this figure is a magnetic drive unit 14, which is located externally below the column 1 in this embodiment. Such drives 14 will be economical for column 1 diameters of up to 300 mm. For larger diameters, such units 14 will be less preferred due to their expense.

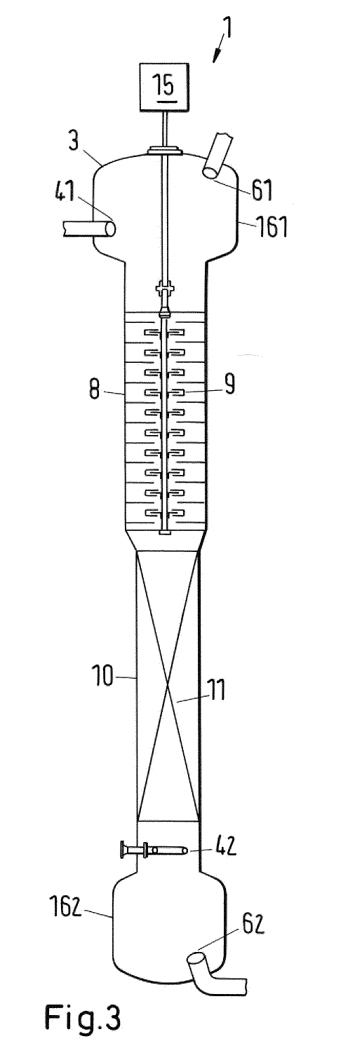

FIG. 3 shows another preferred embodiment of a counter-current liquid-liquid extraction column 1 according to the invention, in which the column 1 is substantially vertical and within the common vessel 3 of the column 1 is only one static section 10 and the mixing section 8 is located substantially above the static section 10. In this embodiment, the agitation means 9 comprises multiple paddle agitators, which are rotated by means of a vertical shaft connected to a motor 15.

As exemplified by this specific embodiment, the column 1 may have different diameters for the mixing section 8 and the one or two static sections 10. One skilled in the art will understand that the diameters of the various sections are not specifically limited but they may be varied based on the common throughput and hydrodynamic requirements of the column 1, as well as economic costs of switching diameters between sections. In one embodiment, the static section(s) 10 has a smaller diameter than the mixing section 8, as exemplified in FIG. 3.

FIG. 4 shows a schematic view of yet another preferred embodiment of a counter-current liquid-liquid extraction column 1 according to the invention, in which the column 1 is substantially vertical and within the common vessel 3 of the column 1 is only one static section 10 and the mixing section 8 is located substantially above the static section 10. As exemplified by this specific embodiment, the column 1 may also comprise one or more collector 12 and/or distributor 13 for the collection and distribution of liquids 2. The embodiment in FIG. 4 has two collectors 12 and two distributors 13, one of each of which are located in each of the top portion 161 and bottom portion 162 of the column 1.

The collectors 12 and distributors 13 are conventional and well-known in the art for the collection of liquids 2 or distribution of liquids 2 in columns 1.

Collector types include chimney tray, Chevron-type, trough liquid, and deck liquid collectors. Collectors 12 are typically used in columns for total draw-off of a liquid to product or pump-around pump down loops, partial draw-off of a liquid with overflow continuing down the column, or collection of liquid for mixing. Typically Chevron-type and trough liquid collector plates require less column height than deck-style collectors, and thus they are preferred where column height is limited.

One skilled in the art will understand that that the performance of a column extractor can be significantly affected by how uniformly the feed and solvent inlet streams are distributed to the cross section of the column 1. The requirements for distribution and redistribution vary depending upon the type of column internals (packing, trays, agitators, or baffles) and the impact of the internals on the flow of dispersed and continuous phases within the column 1. Important aspects of the distributor 13 include the number of holes and the hole pattern (geometric layout), hole size, number of downcomers or upcomers (if used) and their placement, the maximum to minimum flow rates the design can handle (turndown ratio), and resistance to fouling. Liquid distributors 13 are typically used to achieve uniform liquid distribution across the column cross section, and distributors 13 are often located above packing 11. Useful distributor 13 types include splash plate, channel types with bottom holes or lateral tubes, pipe orifice, chimney tray, ladder type, pan, deck, trough, pipe arm, trickling or spraying device, spray condenser, sprinkler, spray, and weir overflow distributors.

As exemplified by this specific embodiment in FIG. 4, the column 1 may also comprise a third inlet 43 for the addition of a third liquid feed stream 53, such as an extractant and/or solvent. The location of the third inlet 43 is not specifically limited, and in some embodiments it will be located between the first inlet 41 and the second inlet 42.

As exemplified also by this specific embodiment in FIG. 4, the agitation means 9 may also be powered by a motor 15 that is side mounted on the column 1.

In this embodiment a horizontal shaft and appropriate gearing is used to rotate the paddle agitators.

As exemplified also by this specific embodiment in FIG. 4, the column 1 may also comprise a pulsing means 200 in fluid connection with the column 1 for increasing the shear stress and the dispersion within the column 1. Suitable pulsing means 200 include a piston pump or a vessel containing inert gas of variable controlled pressure. The pulsing means 200 functions by accelerating droplets of one of the feed streams, 51 to 53, toward the packing 11. As shown in FIG. 4, preferably the pulsing means will be located below the static section 10 and its packing 11 in order to provide the desired effect.

Although not shown in the schematic figures for simplicity, one skilled in the art will understand that other conventional column internals may be used without limitation in the invention, such as feed devices like feed pipes and/or sumps, bed limiters, support plates and grids, dispersers, disperser/support plates, continuous phase distributors, packing support and hold-down plates, entrainment separators, and retainers/redistributors. Suitable column internals are disclosed for example in the technical brochure “Internals for Packed Columns” from Sulzer Chemtech as publication 22.51.06.40-XII.09-50.

Auxiliaries for the column 1 are conventional and well-known in the art and include electrical supplies, level controllers, pumps, valves, pipes and lines, reservoirs, drums, tanks, and sensors for measuring such parameters as flow, temperatures and levels. The column 1 and the extraction process will be conveniently controlled by means of a computer interface equipped with appropriate sensors.

One skilled in the art will understand that the optimum selection and arrangement of the column internals will depend on which phase (light or heavy) is continuous and which is dispersed in the extraction process. Feed pipes to control the velocity of the feeds are recommended.

Another aspect of the invention is a counter-current liquid-liquid extraction process, wherein to a column 1 of the invention, a first liquid feed stream 51 is fed by means of the first inlet 41 and a second liquid feed stream 52 is fed by means of the second inlet 42, liquid-liquid contact occurs between the stream 51 and the stream 52 to form a product stream 71 and a byproduct stream 72, and the formed product stream 71 is removed by means of the first outlet 61, and the formed byproduct stream 72 is removed by means of the second outlet 62.

In many embodiments, it will be preferred to add the denser liquid 2 as a first liquid feed stream 51 to a top portion 161 of the column 1 and the less dense liquid 2 as a second liquid feed stream 52 to a bottom portion 162 of the column 1 in order to take advantage of gravity as a driving force for the process. Likewise it will often be preferred to remove the denser of the product or byproduct streams (71 or 72) from a bottom portion 162, and to remove the less dense stream (71 or 72) from the top portion 161 for the same reason. With reference to the embodiments shown in the drawings, it will be preferred that stream 71 is less dense than stream 72.

This extraction process of the invention has the benefit of making possible a reduction in energy of the process. This is both more economical and makes the process milder, thereby minimizing problems of entrainment or emulsion formation. Without wishing to be bound to any particular mechanism or mode of operation, it is believed that the mixing section 8 dissipates energy by creating interfacial area for separation, whereas adding the one or two static sections 10 allows the energy introduced by the mixing section 8 to be favorably reduced. However using only static sections 10 alone would not introduce enough energy for creating sufficient interfacial area for effective separation and extraction. Using only one mixing section 8 in the column 1 reduces the energy consumption of the column 1 and energy input to the column 1, and minimizes the propagation of emulsions and entrainment through the column. If too many fine droplets, e.g. below a critical size, are generated in the process, it will not be possible to separate them in the end.

Extraction processes are well known in the art, for example, as disclosed in Chemical Engineering Design, Vol. 6, Coulson & Richardson's Chemical Engineering Series, by R. K. Sinnott, John Metcalfe Coulson, and John Francis Richardson, 4th Ed. Published in 2005 by Elsevier (ISBN 0 7506 6538 6) or Handbook of Solvent Extraction by T. C. Lo and M. H. I. Baird, edited by C. Hanson, published in 1991 by Krieger Pub. Co. (ISBN-13: 978-0894645464). Unless indicated otherwise, conventional extraction processes and their various liquids 2 and operating parameters and conditions may be used in the extraction processes according to the invention and making use of the column 1.

Conventional extraction process include fractional extraction, dissociative extraction, pH-swing extraction, reaction enhanced extraction, extractive reaction, temperature-swing extraction, reversed micellar extraction, aqueous two-phase extraction. Hybrid extraction processes include extraction-distillation, extraction-crystallization, neutralization extraction, reaction-extraction, and reverse osmosis extraction.

It will often be preferred in some embodiments to disperse the liquid feed stream 51 or 52 with the higher flow rate in order to generate maximum interfacial content. In other embodiments, the liquid 2 with the lower flow rate will preferably be dispersed when the liquid 2 with the higher flow rate has a higher viscosity or preferentially wets the packing surface.

It is noted that the presence of any surfactants may alter surface properties to such an extent that the performance of the extraction process cannot be accurately predicted. Therefore preferred embodiments of the process will take place in the absence of any significant surfactant content.

In addition to the being easily recoverable and recyclable, the solvent liquid used in liquid-liquid solvent extraction should have a high selectivity (ratio of distribution coefficients), be immiscible with the carrier liquid, have a low viscosity, and have a high density difference (compared to the carrier liquid) and a moderately low interfacial tension. Common industrial solvents generally are single-functionality organic solvents such as ketones, esters, alcohols, linear or branched aliphatic hydrocarbons, aromatic hydrocarbons, and so on; or water, which may be acidic or basic or mixed with water-soluble organic solvents. More complex solvents are sometimes used to obtain specific properties needed for a given application. These include compounds with multiple functional groups such as diols or triols, glycol ethers, and alkanol amines as well as heterocyclic compounds such as pine-derived solvents (terpenes), sulfolane (tetrahydrothiophene-1,1-dioxane), and NMP (N-methyl-2-pyrrolidinone). In some embodiments, blends of the above-disclosed solvents may be used to improve the solvent properties for certain applications.

In a preferred embodiment of the process according to the invention, the column 1 is substantially vertical, preferably wherein within the common vessel 3 of the column 1 is only one static section 10, and wherein the mixing section 8 is preferably located substantially above the static section 10, and wherein the density of the stream 52 is less than the density of the stream 51, and wherein the inlet 41 is located within a top portion 161 of the column 1 and the inlet 42 is located within a bottom portion 162 of the column 1. It is generally preferred to add a higher density stream to the top portion 161 of the column 1 and a lower density stream to the lower portion 162 of the column 1 in order to take advantage of the density differences and gravity as a driving force for the counter-current flow. Likewise it will generally be preferred to remove the lighter stream (71 or 72) from the top portion 161 and the heavier stream (71 or 72) from the bottom portion 162. With reference to the embodiments shown in the drawings, it will be preferred that stream 71 is less dense than stream 72. In preferred specific embodiments, the density difference between stream 52 and stream 51 is greater than 5 kg/m³, preferably greater than 15, more preferably greater than 20, and most preferably greater than 30.

In other preferred embodiments of the process, the streams 51 and 52 will have an interfacial tension of greater than 0.5 mN/m, preferably greater than 1, more preferably greater than 2. In other preferred embodiments, the streams 51 and 52 will have viscosities of less than 750 mPas, preferably less than 500, and more preferably less than 250. The use of such interfacial tensions and viscosities will contribute to the efficiency of the extraction process.

In another preferred embodiment of the process according to the invention, the stream 51 comprises water and stream 52 comprises two or more organic compounds, preferably wherein stream 51 consists essentially of water and stream 52 consists consists essentially of organic compounds. The use of organic and aqueous streams is often desired in many extraction processes of commercial importance. Furthermore organic and aqueous streams often have large-scale differences in their density and other physical properties, and the relative differences in these physical properties change significantly over the column 1 as mass transfer progresses. For example, most organic solvents are significantly less dense than water, however, halogenated solvents such as dichloromethane or chloroform are significantly denser than water. Therefore such streams particularly benefit from the column 1 and process of the invention. In many preferred embodiments of the process involving non-halogenated organics, the primarily organic stream 52 will have a lower density and be added via the inlet 42 located within a bottom portion 162 of the column 1, and the primarily aqueous stream 51 will have a higher density and be added via the inlet 41 located within a top portion 161 of the column 1. In these preferred embodiments, the less dense and primarily organic product stream 71 will be removed by an outlet 61 located within a top portion 161 and the denser primarily aqueous byproduct stream 72 by an outlet 62 located with the bottom portion 162. In extractions involving halogenated organics and water, the denser organic phase will preferably be added to the top portion 161 and the aqueous phase to the bottom portion 162, and the denser organic byproduct stream 72 removed by outlet 62 in the bottom portion 162 and the lighter aqueous product stream 71 by outlet 61 in the top portion 161.

In yet another preferred embodiment of the process, the stream 51 comprises a solvent, and the stream 52 comprises an oil and an aromatic compound, wherein the aromatic compound is extracted from the stream 52 by counter-current contact with stream 51 within the column 1 to yield a purified oil, wherein the extracted aromatic compound is removed with the solvent as part of a byproduct stream 72 by means of outlet 62 located within the bottom portion 162 of the column 1, and wherein the purified oil is removed as part of a product stream 71 by means of outlet 61 located within the top portion 161 of the column 1. The oil and aromatic compound are not specifically limited. Useful oils include hydrocarbon streams such as the output of a fluid catalytic cracker, white spirit oil, or lubricant oil. Useful aromatics include benzene, toluene, xylene, phenol and polycyclic aromatic compounds such as asphaltic, tar or naptha compounds.

In yet another preferred embodiment of the process, a third liquid feed stream 53 having a density greater then the density of stream 52 but less than the density of stream 51 is added to the column by means of a third inlet 43 located between the inlet 42 and the inlet 41. In many extractions it will be favorable to add extractants or co-solvents to increase the capacity of the solvent phase for the component(s) to be extracted. In certain specific preferred embodiments, the third stream 53 is another solvent, for example, a solvent for washing, stripping or scrubbing. In this manner the extraction process in the column 1 may be effectively combined together with a scrubbing, stripping or washing step within the same column 1.

As discussed earlier for the column 1, in a preferred embodiment of the process, a liquid 2 within the column 1 is pulsed by a pulsing means 200 in order to increase the shear stress on and the dispersion of the liquid 2.

Yet another aspect of the present invention is the use of the extraction column 1 or the extraction process of the invention in removing aromatic compounds from organic streams, in treating an oil stream of a refinery, or in a liquid-liquid extraction process having at least two feed streams of different density, interfacial tension or viscosity and/or involving high extents of mass transfer.

### EXAMPLES

The following examples are set forth to provide those of ordinary skill in the art with a detailed description of how the counter-current liquid-liquid extraction columns 1, processes, and uses claimed herein are evaluated, and they are not intended to limit the scope of what the inventors regard as their invention.

In these examples, a column 1 as shown in FIG. 3 was successfully used in a typical application for the liquid-liquid extraction of aromatic compounds from an oil. The column packing was a Sulzer SMV extraction structured packing.

In these examples, a typical oil and solvent combination as well-known in the art was used. The first liquid stream 51 was an organic solvent NMP, which was of higher density and fed to the column 1 using an inlet 41 located within the top portion 161 of the column 1. The second liquid feed stream 52 was mineral oil, which contained aromatic compounds detectable by ASTM method IP346. The mineral oil has a density less than that of NMP, and it was fed to the bottom portion 162 of the column 1 using inlet 42.

During the process the oil was contacted with the organic solvent to remove the aromatic components from the feed oil. The denser loaded solvent, the so called extract, left the bottom portion 162 of the column 1 as a byproduct stream 72 by means of second outlet 62, and the purified oil, the so called raffinate, left the top portion 161 of the column 1 as a product stream 71 by means of first outlet 61. In this case the density difference of the feed oil and the loaded solvent (extract) was very low, which was one key challenge for operating the extraction column 1.

In a comparative trial, the extraction process was applied in a Sulzer-Kühni agitated column having a mixing section 8 but no static sections 10, and it was unfortunately not possible to operate the agitated column with stable hydrodynamic conditions. The lack of significant density difference between the extract and the feed oil made the operation in the agitated column extremely instable.

In a second comparative trial, the extraction process was applied to a Sulzer packed extraction column having a static section 10 containing an SMV packing but having no agitation means 9 or mixing section 8. It was possible to reach a steady state of the column having stable hydrodynamic conditions. The low density difference could be handled in the packed column having no mixing section 8. However, the desired product purity of the raffinate was not achieved because the separation performance of the packed column having only a static section 10—but no mixing section 8 or agitation means 9—was significantly lower than the separation performance of the agitated column having only a mixing section 8 but no static section 10.

In a third working trial, the above described combined packed and agitated extraction, as shown in FIG. 3, was use to carry out the extraction process. The bottom part of the column 1, in which the low density difference between the liquids 2 was observed, was installed as a packed column (static section 10) to cope with the challenging hydrodynamic conditions there. In order to provide a high separation performance and thus a high purity and quality of the raffinate, the upper part of the column 1 was installed as an agitated column (mixing section 8 with agitation means 9).

By this combination, the advantages of the separate packed and the agitated column were combined as a static section 10 and a mixing section 8 within one common vessel 3 of a single apparatus (the counter-current liquid-liquid extraction column 1). In this column 1, no internals such as a collector 12 or a distributor 13 were required between the static section 10 and the mixing section 8. Furthermore this column 1 did not require more than one shell, set of feed pumps, or process controllers. Therefore the advantageous properties of two different column types could be achieved in one simple single column 1 and without the need for large numbers of auxiliaries or column internals or elaborate process control means. In addition, the required raffinate purity was achieved, and no issues with emulsion formation or entrainment were observed during the stable operation of this column 1 shown in FIG. 3 in the extraction of the aromatic compounds from the mineral oil using NMP as solvent.

While various embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1-15. (canceled)

16. A counter-current liquid-liquid extraction column adapted for the flow of two or more liquids therein and comprising within one common vessel:
a first inlet for a first liquid feed stream,
a second inlet for a second liquid feed stream,
a first outlet for a product stream,
a second outlet for a byproduct stream,
a mixing section comprising an agitation means,
a static section comprising a packing,
wherein only one mixing section and only either one or two static sections are present within the common vessel.

17. The column of claim 16, further comprising at least one of a collector and a distributor.

18. The column of claim 16, wherein the column is substantially vertical, wherein only one static section is present within the common vessel.

19. The column of claim 18, wherein the mixing section is located substantially above the static section.

20. The column of claim 18, wherein the column additionally comprises at least one of a collector and a distributor.

21. The column of claim 16, wherein no collector or distributor is located between the mixing section and the one or two static sections.

22. The column of claim 16, wherein the agitation means comprises either a magnetic drive unit or a motor, wherein the motor is located substantially above or substantially to the side of the mixing section.

23. The column of claim 16, wherein the packing comprises trays, a random packing, a structured packing, or combinations thereof.

24. The column of claim 16, wherein the column additionally comprises a third inlet located between the first inlet and the second inlet and for the addition of a third liquid feed stream.

25. The column of claim 16, wherein the column additionally comprises a pulsing means in fluid connection with the column for increasing shear stress and dispersion within the column.

26. A counter-current liquid-liquid extraction process, wherein to a column adapted for the flow of two or more liquids therein and comprising within one common vessel: a first inlet, a second inlet, a first outlet, a second outlet, a mixing section comprising an agitation means, and a static section comprising a packing, with only one mixing section and only either one or two static sections being present within the common vessel,
a first liquid feed stream is fed by means of the first inlet and a second liquid feed stream is fed by means of the second inlet,
liquid-liquid contact occurs between the first liquid feed stream and the second liquid feed stream to form a product stream and a byproduct stream,
and the formed product stream is removed by means of the first outlet, and the formed byproduct stream is removed by means of the second outlet.

27. The process of claim 26, wherein the column is substantially vertical.

28. The process of claim 26, wherein within the common vessel of the column is only one static section.

29. The process of claim 26, wherein the mixing section is located substantially above the static section, and wherein the density of the second liquid feed stream is less than the density of the first liquid feed stream, and wherein the first inlet is located within a top portion of the column and the second inlet is located within a bottom portion of the column.

30. The process of claim 26, wherein the second liquid feed stream comprises two or more organic compounds and the first liquid feed stream comprises water.

31. The process of claim 30, wherein the second liquid feed stream consists essentially of organic compounds and the first liquid feed stream consists essentially of water.

32. The process of claim 26, wherein the first liquid feed stream comprises a solvent and the second liquid feed stream comprises an oil and an aromatic compound, and wherein the aromatic compound is extracted from the second liquid feed stream by counter-current contact with the first liquid feed stream within the column to yield a purified oil, wherein the extracted aromatic compound is removed with the solvent as part of a byproduct stream by means of the second outlet located within the bottom portion of the column, and wherein the purified oil is removed as part of a product stream by means of the first outlet located within the top portion of the column.

33. The process of claim 26, wherein a third liquid feed stream having a density greater then the density of the second liquid feed stream but less than the density of the first liquid feed stream is added to the column by means of a third inlet located between the second inlet and the first inlet.

34. The process of claim 26, wherein a liquid within the column is pulsed by a pulsing means in order to increase the shear stress on and the dispersion of the liquid.

35. Use of the column of claim 16, in removing aromatic compounds from organic streams, in treating an oil stream of a refinery, or in a liquid-liquid extraction process having at least two feed streams of different density, interfacial tension or viscosity.
